(19) United States
(12) Patent Application Publication
(10) Pub. No.: US 2011/0235333 A1
(43) Pub. Date: Sep. 29, 2011

(54) LIGHTING DEVICE

(76) Inventors: Teruo Koike, Tokyo (JP); Satoshi Moriguchi, Tokyo (JP)

(21) Appl. No.: 13/072,660

(22) Filed: Mar. 25, 2011

(30) Foreign Application Priority Data
Mar. 25, 2010 (JP) 2010-070048

(51) Int. Cl. F21V 17/02; F21V 5/00

(52) U.S. Cl. 362/277; 362/311.01

(57) ABSTRACT

A lighting fixture can have a reduced depth size. The lighting device can include an LED light source, and a lens body disposed in front of the LED light source to be opposed to the LED light source. The lens body can includes a front light exiting surface and a rear surface that includes a light incident surface on which light emitted from the LED light source can be incident. The light incident surface can be a cylindrically recessed light incident surface that is formed by moving a concave semicircle section with respect to the LED light source in one direction to define a recessed space, and the LED light source is disposed within the recessed space defined by the light incident surface so that the light emitted from the LED light source is incident on the light incident surface.

This application claims the priority benefit under 35 U.S.C. §119 of Japanese Patent Application No. 2010-070048 filed on Mar. 25, 2010, which is hereby incorporated in its entirety by reference.

### TECHNICAL FIELD

The presently disclosed subject matter relates to a lighting device, and in particular, to a lighting device to be disposed at a lower position.

### BACKGROUND ART

Lighting devices with a projector type optical system have been proposed as conventional lighting devices for street lights (see, for example, Japanese Patent Application Laid-Open No. 2003-36705).

For example, as shown in FIG. 1, a lighting device 400 disclosed in Japanese Patent Application Laid-Open No. 2004-36705 can include a light source 410, a reflecting mirror 420 configured to converge light beams from the light source 410 and a projector lens 430 configured to convert the converged light beams from the light source 410 by the reflecting mirror 420 to parallel light beams so as to project the parallel light beams onto a road surface, and the like.

The lighting device 400 with the above configuration, however, has problems in which its size in the deeper direction (depth) may be large due to its configuration and the disposition conditions therefore may be limited.

Another problem may arise in which the lighting device 400 with the above configuration must be adjusted in angle with respect to the plurality of components including the reflection minors 420, the projection lens 430, and the like.

When the lighting device 400 is disposed at a lower position, for example, approximately 1 m high from a road surface, a glare directed toward the driver of an oncoming vehicle may occur due to the upward light generated from the lighting device.

Furthermore, if the lighting devices 400 with the above configuration are disposed at certain intervals as shown in FIGS. 2A and 2B, it may be difficult to illuminate a road surface near the road shoulder between the lighting devices 400. Accordingly, it is difficult to improve the illumination uniformity (uniformity ratio of illuminance) in the illumination area.

### SUMMARY

The presently disclosed subject matter was devised in view of these and other problems and features and in association with the conventional art. According to an aspect of the presently disclosed subject matter, a lighting device can be configured to have a depth dimension that is smaller than a conventional lighting device, and to provide a desired light distribution pattern without any adjustment of the angular postures of a plurality of components such as reflecting minors, projection lenses, and the like while the lighting device can prevent glare light from occurring (i.e, suppressing glare) toward a driver of an oncoming vehicle even if the lighting device is disposed at a lower position, for example, 1 m high from a road surface. According to another aspect of the presently disclosed subject matter, a lighting device can illuminate a road surface including areas near the road shoulder between adjacent lighting devices with light even if the lighting devices are disposed at certain intervals along the road shoulder. Accordingly, it is possible to improve the illumination uniformity (uniformity ratio of illuminance) in the illumination area.

According to still another aspect of the presently disclosed subject matter, a lighting device can be configured to include an LED light source, and a lens body disposed in front of the LED light source so as to be opposed to the LED light source, the lens body including a front light exiting surface and a rear surface that includes a light incident surface on which light emitted from the LED light source can be incident. In this configuration, the light incident surface can be a cylindrically recessed light incident surface that can be formed by moving (extending) a concave semicircle section with respect to the LED light source in one direction to define a recessed space, and the LED light source can be disposed within the recessed space defined by the light incident surface so that the light emitted from the LED light source can be incident on the light incident surface.

The lighting device with the above configuration can have a depth dimension significantly smaller than conventional lighting devices because the lighting device can be composed of a simple combination of the LED light source and the lens body.

The lighting device with the above configuration can provide a desired light distribution pattern by adjusting only an angular posture of the lens body because the lighting device can be composed of a simple combination of the LED light source and the lens body.

The lighting device with the above configuration can provide the directivity characteristics (direct lighting) required for a road illumination light by the action of the cylindrically recessed light incident surface. With such a directivity, the lighting device can horizontally diffuse light beams to a wider horizontal area while effectively suppressing upward light that may be a cause of glare light.

The lighting device with the above configuration can horizontally diffuse light to a wider area and illuminate a road surface including areas near its road shoulder between adjacent lighting devices with light even if the lighting devices are disposed at certain intervals along the road shoulder. Accordingly, it is possible to improve the illumination uniformity (uniformity ratio of illuminance) in the illumination area.

According to still another aspect of the presently disclosed subject matter, in the lighting device with the above configuration, the light exiting surface can be a lens surface that can horizontally diffuse the light that is emitted from the LED light source and enters the lens body through the light incident surface while projecting the light that can illuminate the range from the optical axis of the lens body up to 40 degrees.

The lighting device with the above configuration can provide the directivity characteristics required for a road illumination light by the action of the cylindrically recessed light incident surface. With such a directivity, the lighting device can horizontally diffuse light beams to a wider horizontal area while effectively suppressing the upward light that may be a cause of glare light.

According to still another aspect of the presently disclosed subject matter, in the lighting device with the above configuration, the light exiting surface can be a lens surface that can horizontally diffuse the light that is emitted from the LED light source and enters the lens body through the light incident surface in a horizontal angle range of from 85 degrees leftward to 85 degrees rightward while projecting the light that can illuminate the range within a vertical range from the optical axis of the lens body up to 40 degrees.

The lighting device with the above configuration can provide the directivity characteristics required for a road illumination light by the action of the cylindrically recessed light incident surface. With such a directivity, the lighting device can horizontally diffuse light beams to a wider horizontal area while effectively suppressing the upward light that may be a cause of glare light.

According to still another aspect of the presently disclosed subject matter, in the lighting device with the above configuration, the light exiting surface can be a lens surface that can horizontally diffuse the light that is emitted from the LED light source and enters the lens body through the light incident surface in a horizontal angle range of from 85 degrees leftward to 85 degrees rightward while projecting the light that can illuminate the range within a range from the optical axis of the lens body up to 15 degrees.

The lighting device with the above configuration can provide the directivity characteristics required for a road illumination light by the action of the cylindrically recessed light incident surface. With such a directivity, the lighting device can horizontally diffuse light beams to a wider horizontal area while effectively suppressing the upward light that may be a cause of glare light.

According to still another aspect of the presently disclosed subject matter, a lighting device can include a first optical module, a second optical module, and a third optical module, each of the first to third optical modules including an LED light source and a lens body disposed in front of the LED light source to be opposed to the LED light source, the lens body including a front light exiting surface and a rear surface that includes a light incident surface on which light emitted from the LED light source can be incident. In this configuration, the light incident surface can be a cylindrically recessed light incident surface that can be formed by moving (extending) a concave semicircle section with respect to the LED light source in one direction to define a recessed space, and the LED light source can be disposed within the recessed space defined by the light incident surface so that the light emitted from the LED light source can be incident on the light incident surface, and the second optical module and the third optical module can be disposed on respective sides of the first optical module.

The lighting device with the above configuration can have a depth dimension significantly smaller than conventional lighting devices because the lighting device can be composed of a simple combination of the LED light source and the lens body.

The lighting device with the above configuration can provide a desired light distribution pattern by adjusting only an angular posture of the lens body because the lighting device can be composed of a simple combination of the LED light source and the lens body.

The lighting device with the above configuration can provide the directivity characteristics required for a road illumination light by the action of the cylindrically recessed light incident surface. With such directivity, the lighting device can horizontally diffuse light beams to a wider horizontal area while effectively suppressing the upward light that may be a cause of glare light.

The lighting device with the above configuration can horizontally diffuse light to a wider area and illuminate a road surface including areas near its road shoulder between adjacent lighting devices with light even if the lighting devices are disposed at certain intervals along the road shoulder. Accordingly, it is possible to improve the illumination uniformity (uniformity ratio of illuminance) in the illumination area.

According to still another aspect of the presently disclosed subject matter, in the lighting device with the above configuration, the second optical module can be disposed with its posture inclined outward with respect to the first optical module so that light projected from the second optical module can cover an area outside a horizontally diffused area illuminated with light projected from the first optical module, and the third optical module can be disposed with its posture inclined outward with respect to the first optical module so that light projected from the third optical module can cover an area outside a horizontally diffused area illuminated with light projected from the first optical module.

The lighting device with the above configuration can widen the horizontal illumination area more than the case where the second and third optical modules are not inclined, by the action of the second and third optical modules disposed on the respective sides of the first optical module with the postures being inclined.

As described above and according to an exemplary embodiment, first the lighting device can be configured to have a depth dimension smaller than a conventional lighting device. Secondly, the lighting device can be configured to provide a desired light distribution pattern without any adjustment of angular postures of a plurality of components such as reflecting minors, projection lenses, and the like. Thirdly, the lighting device can prevent glare light from occurring (i.e., can suppress glare) toward the driver of an oncoming vehicle even if the lighting device is disposed at a lower position, for example, 1 m high from a road surface. Furthermore, the lighting device can illuminate a road surface including areas near its road shoulder between adjacent lighting devices with light even if the lighting devices are disposed at certain intervals along the road shoulder. Accordingly, it is possible to improve the illumination uniformity (uniformity ratio of illuminance) in the illumination area.

### BRIEF DESCRIPTION OF DRAWINGS

These and other characteristics, features, and advantages of the presently disclosed subject matter will become clear from the following description with reference to the accompanying drawings, wherein:

FIG. 1 a schematic diagram illustrating the configuration of a conventional lighting device;

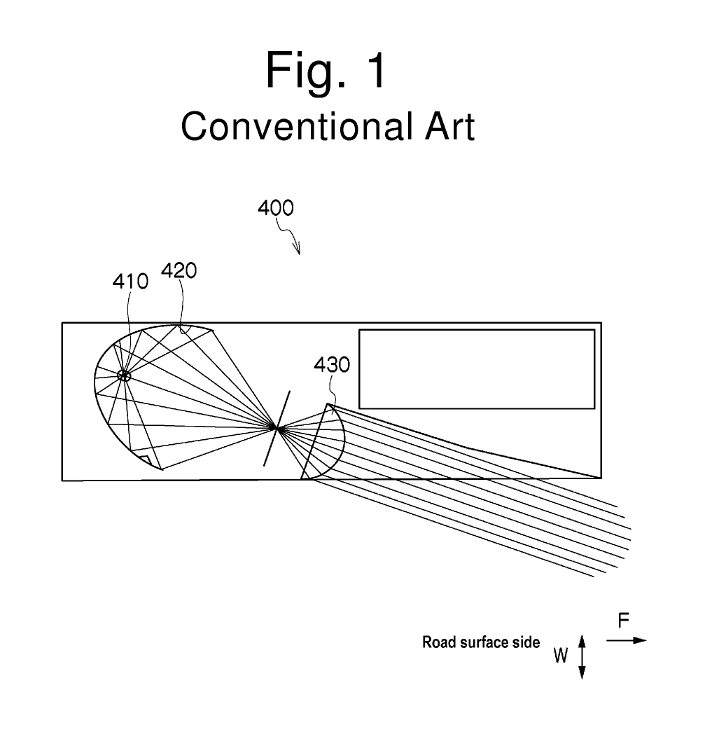

FIG. 2A is a plan view of a road surface area that is illuminated with light from lighting devices disposed at 10 m intervals, and FIG. 2B is a perspective view of the road surface shown in FIG. 2A;

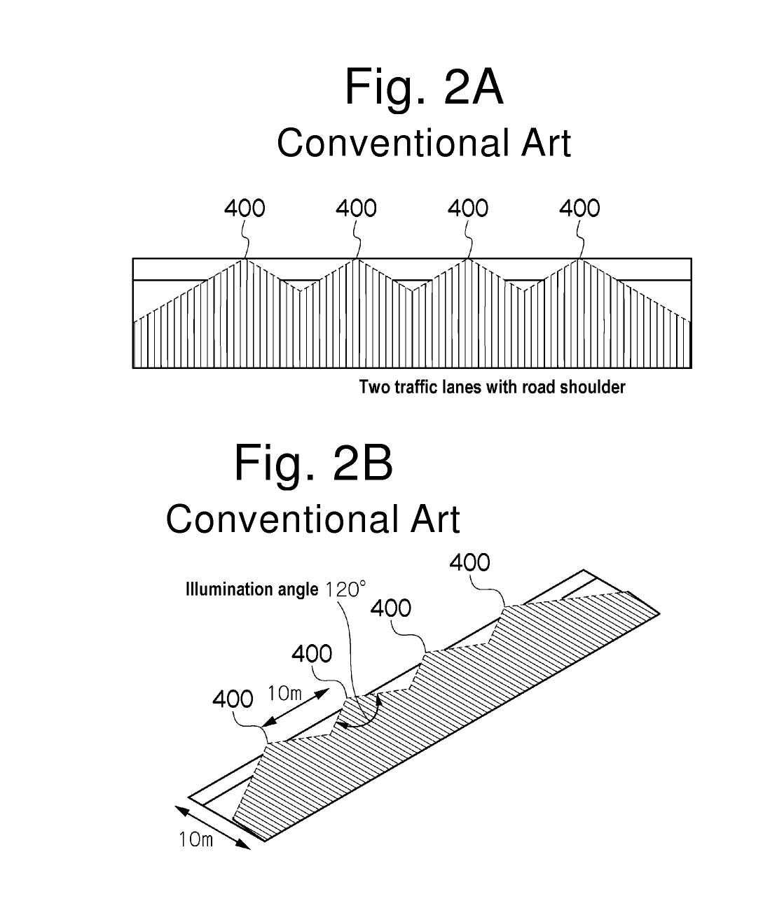

FIG. 3 is a perspective view illustrating an exemplary optical module or lighting device made in accordance with principles of the presently disclosed subject matter;

FIG. 4A is a front view showing the optical module of FIG. 3, FIG. 4B is a horizontal cross sectional view of the optical module of FIG. 3 taken along line B-B in FIG. 4A, and FIG. 4C is a vertical cross sectional view of the optical module of FIG. 3 taken along line A-A in FIG. 4A;

FIG. 5A is a perspective view of a light incident surface of a comparative domed recess, FIG. 5B is a horizontal cross sectional view of an optical module including the light incident surface of FIG. 5A with optical paths illustrated, FIG. 5C is a vertical cross sectional view of the optical module including the light incident surface of FIG. 5A with optical paths illustrated, and FIG. 5D is a perspective view of the optical module including the light incident surface of FIG. 5A with optical paths illustrated;

FIG. 6A is a table indicating the vertical directivity characteristics of the optical module shown in FIGS. 5B to 5D, and FIG. 6B is a table indicating the horizontal directivity characteristics of the optical module shown in FIGS. 5B to 5D;

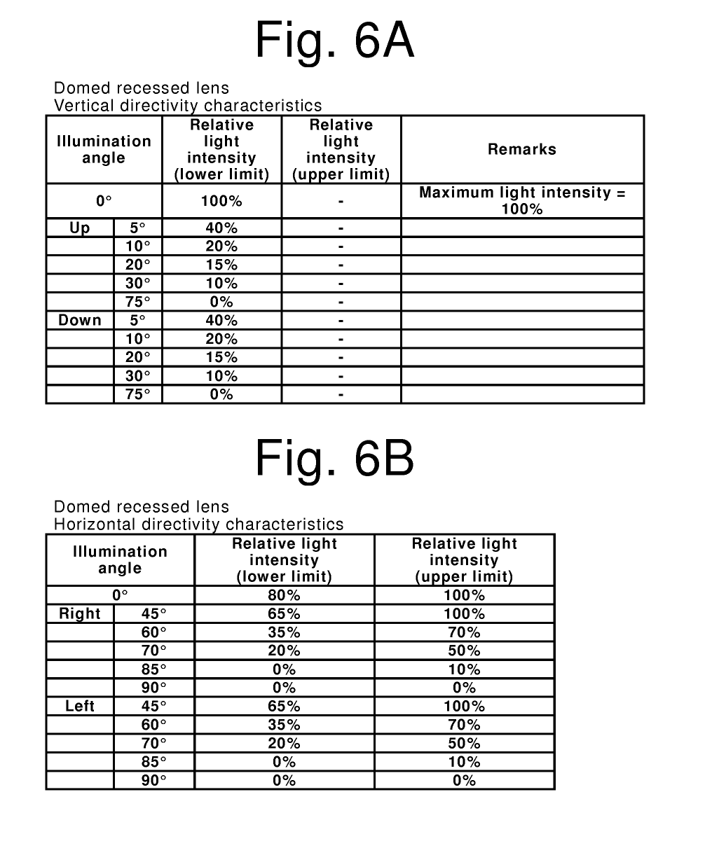

FIG. 7A is a perspective view of a light incident surface of a cylindrical recess, FIG. 7B is a horizontal cross sectional view of an optical module including the light incident surface of FIG. 7A with optical paths illustrated, FIG. 7C is a vertical cross sectional view of the optical module including the light incident surface of FIG. 7A with optical paths illustrated, and FIG. 7D is a perspective view of the optical module including the light incident surface of FIG. 7A with optical paths illustrated;

FIG. 8 is a graph showing the horizontal directivity characteristics of the optical module including the light incident surface shown in FIGS. 7A to 7D in which the vertical axis represents a relative intensity and the horizontal axis represents horizontal angle (widthwise angle) with respect to an optical axis of the lens body;

FIG. 9 is a graph showing the vertical directivity characteristics of the optical module including the light incident surface shown in FIGS. 7A to 7D in which the vertical axis represents a relative intensity and the horizontal axis represents vertical angle with respect to an optical axis of the lens body;

FIG. 10A is a table indicating the vertical directivity characteristics of the optical module shown in FIGS. 7B to 7D, and FIG. 10B is a table indicating the horizontal directivity characteristics of the optical module shown in FIGS. 7B to 7D;

FIG. 11A is a front view showing an exemplary optical module according to another aspect of the presently disclosed subject matter, FIG. 11B is a horizontal cross sectional view of the optical module taken along line B-B in FIG. 11A, and FIG. 11C is a vertical cross sectional view of the optical module taken along line A-A in FIG. 11A;

FIG. 12 is a schematic diagram illustrating how a lighting device is disposed along a road shoulder;

FIG. 13A is a plan view of a road surface area that is illuminated with light from the lighting devices of FIG. 11A to 11C disposed at 10 m intervals, and FIG. 13B is a perspective view of the road surface shown in FIG. 13A;

FIG. 14 is a graph showing an exemplary road surface light distribution illuminated with light from respective lighting devices disposed at 10 m intervals (unit: Lux);

FIG. 15A is a front view showing an exemplary optical module according to still another aspect of the presently disclosed subject matter, FIG. 15B is a horizontal cross sectional view of the optical module taken along line B-B in FIG. 15A, and FIG. 15C is a vertical cross sectional view of the optical module taken along line A-A in FIG. 15A;

FIG. 16A is a plan view of a road surface area that is illuminated with light from the lighting devices of FIG. 15A to 15C disposed at 12 m intervals, and FIG. 16B is a perspective view of the road surface shown in FIG. 16A; and

FIG. 17 is a graph showing an exemplary road surface light distribution illuminated with light from respective lighting devices disposed at 12 m intervals (unit: Lux).

### DESCRIPTION OF EXEMPLARY EMBODIMENTS

A description will now be made below to lighting devices of the presently disclosed subject matter with reference to the accompanying drawings in accordance with exemplary embodiments.

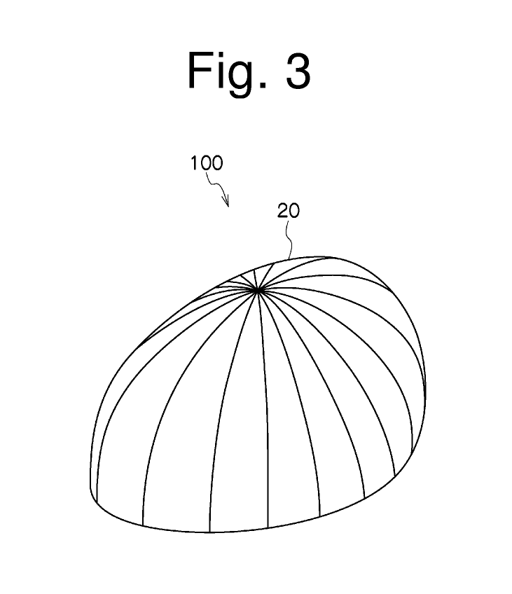

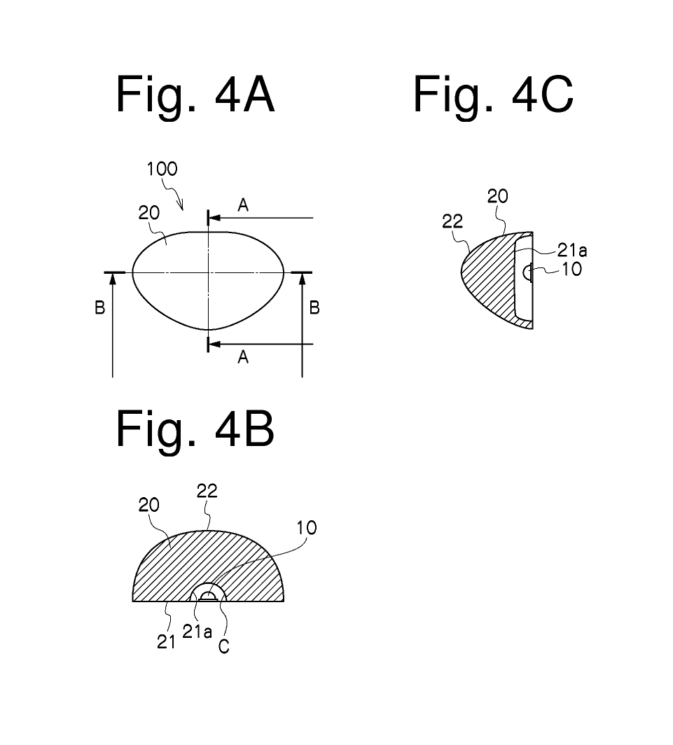

A lighting device 100 according to the present exemplary embodiment (hereinafter, referred to as an optical module 100) can be suitably applied to a road illumination light, a sidewalk light, a parking light, and the like. As shown in FIGS. 3 and 4A to 4C, the optical module 100 can include an LED light source 10 and a lens body 20 disposed in front of the LED light source 10 and be opposed to the LED light source 10. It should be understood that the plurality of radially extending lines on the lens body 20 in FIG. 3 are virtual lines for showing the three dimensional appearance of the lens body 20.

The LED light source 10 can be a white LED light source, for example.

As shown in FIGS. 4B and 4C, the lens body 20 can be disposed so as to be opposite to the LED light source 10 and can be a solid lens body including a front light exiting surface 22 and a rear surface 21 that include a light incident surface 21a on which light emitted from the LED light source 10 can be incident. The lens body 20 can be formed of a light transmitting material such as acrylic resin, polycarbonate resin, and the like.

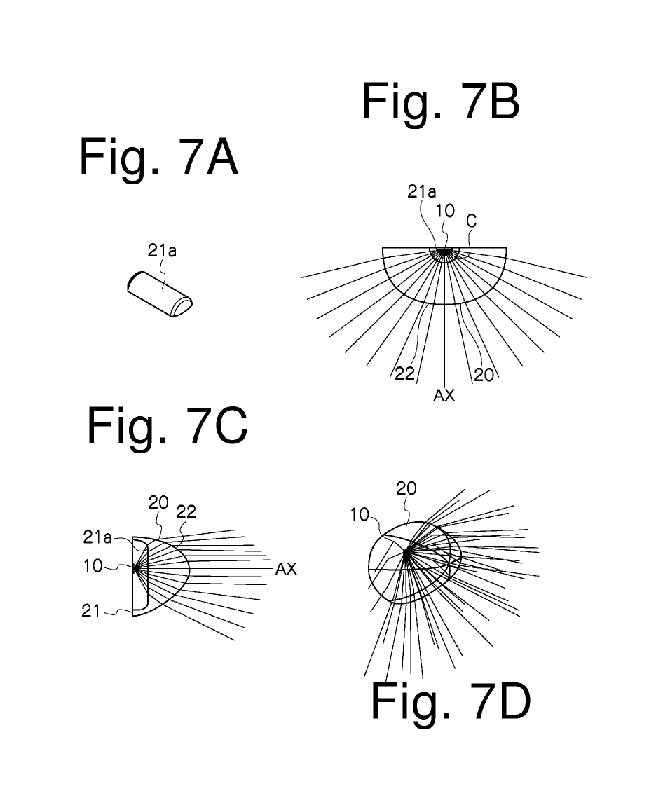

In this configuration, the light incident surface 21a can be a cylindrically recessed light incident surface (see FIG. 7A) that can be formed by moving (extending) a concave semicircle section C (see FIG. 4B) with respect to the LED light source 10 in one direction (vertical direction as shown in FIG. 4C) to define a recessed space, and the LED light source 10 can be disposed within the recessed space defined by the light incident surface 21a so that the light emitted from the LED light source 10 can be incident on the light incident surface 21a. This can enhance the light utilization efficiency.

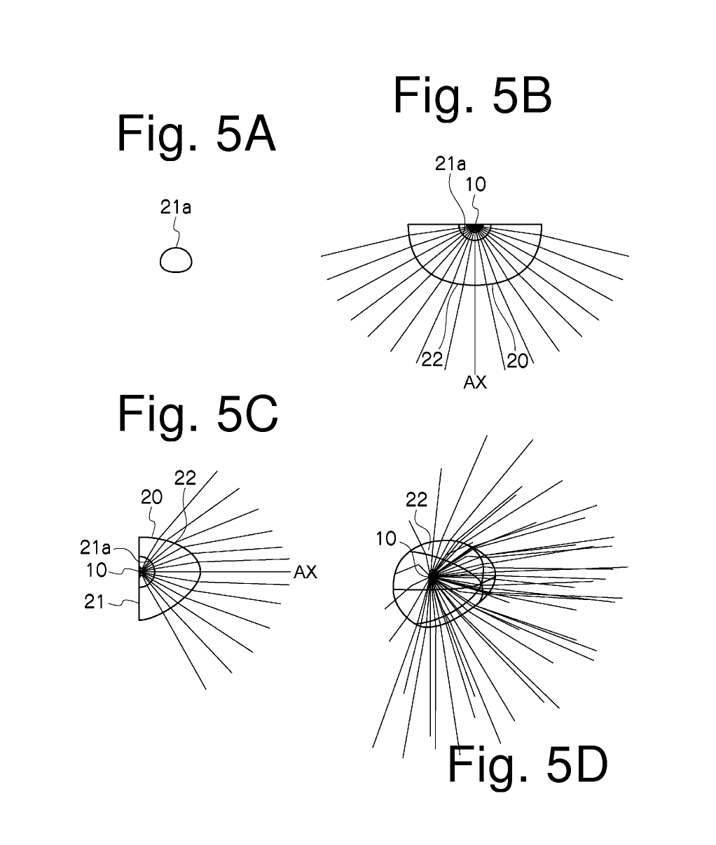

The light incident surface 21a can be formed of a domed recessed surface (hemispheric surface) as shown in FIG. 5A. In this case, the horizontal cross section and the vertical cross section of the light incident surface 21a both are a half circle (or circular arc) as shown in FIGS. 5B and 5C. In this configuration, the light incident angle of light emitted from the LED light source 10 with respect to the light incident surface 21a may be close to 0 degrees as shown in FIGS. 5B and 5C. This means that the light from the LED light source 10 is not refracted at the light incident surface 21a to enter the lens body while the light exits from the light exiting surface with refraction in the horizontal and vertical directions (see FIGS. 3B to 3D).

In this configuration, however, with the single refraction by the light exiting surface 22, it is possible to refract the upward light (that is a cause of glare light) only by 40 degrees or so. Accordingly, the lighting device with the above configuration of FIG. 5A to 5D cannot refract the light by lower angles than 40 degrees, and thus, cannot achieve the directivity characteristics required for a road illumination light. Namely, such a lighting device cannot provide directivity characteristics resulting from the horizontally wide diffusion and the effective suppression of glare light by preventing the upwardly illuminated light.

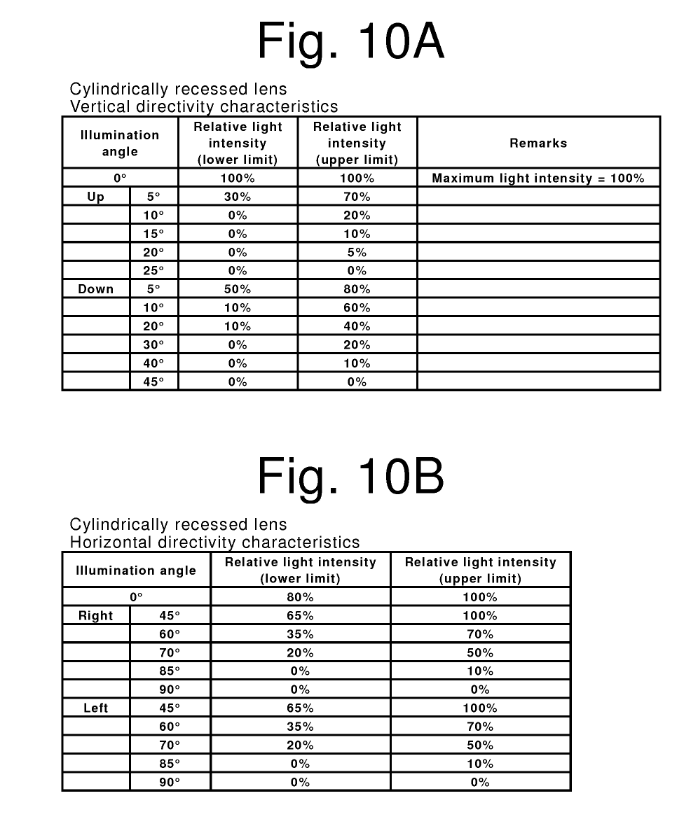

In order to solve the above problems associated with the conventional lighting devices, the present inventors have found that the light incident surface 21a should be formed into a vertically extending, cylindrical recessed light incident surface as shown in FIGS. 4B, 4C, and 7A, rather than a domed recess. With this configuration, the horizontal cross section of the cylindrical recessed light incident surface 21a can be a semicircle (or circular arc) as shown in FIG. 4B while the vertical cross section thereof can be a straight line as shown in FIG. 4C. Namely, with respect to the horizontal direction, the light emitted from the LED light source 10 can be incident on the light incident surface 21a by a light incident angle near or at 0 degrees (see FIG. 7B), so that the light from the LED light source 10 cannot be refracted at the light incident surface 21a while it can be refracted only at the light exiting surface 22. This configuration can achieve sufficient light diffusion in a wider horizontal area as shown in FIGS. 7B, 8, and 10B. On the contrary, with respect to the vertical direction, the light emitted from the LED light source 10 can be incident on the light incident surface 21a by a light incident angle near or at 90 degrees at farther sides (see FIG. 7C). Accordingly, the light from the LED light source 10 can be refracted at the light incident surface 21a and then further refracted at the light exiting surface 22 (being refracted twice as shown in FIG. 7C), so that the generation of any upward light that may be a cause of glare light can be suppressed. Namely, this can be achieved by projecting the refracted light by 40 degrees or lower with respect to the horizontal line (standard road surface direction) (see FIGS. 7C, 9, and 10A). Thus, if the light incident surface 21a is not domed but cylindrically recessed in the vertical direction (see FIGS. 4B, 4C, and 7A), the lighting device with the above configuration can provide the directivity characteristics required for a road illumination light by the action of the cylindrically recessed light incident surface. With such directivity, the lighting device can horizontally diffuse light beams while effectively suppressing the upward glare light.

Based on the above concept, the light incident surface 21a is not formed to be a domed shape, but is a vertically extending, cylindrically recessed light incident surface as shown in FIGS. 4B, 4C and 7A.

As shown in FIGS. 7B and 7C, in the lighting device with the above configuration, the light exiting surface 22 can be a lens surface that can horizontally diffuse the light that is emitted from the LED light source 10 and enters the lens body 20 through the light incident surface 21a, for example, in a horizontal angle range of from 85 degrees leftward to 85 degrees rightward (as shown in FIGS. 7B, 8, and 10B) while projecting the light that can illuminate the range within a vertical range from the optical axis AX of the lens body 20 up to 40 degrees, and preferably up to 15 degrees as shown in FIGS. 7CB, 9, and 10A.

The optical module 100 with the above configuration can have a depth dimension significantly smaller than conventional lighting devices because the optical module 100 can be composed of a simple combination of the LED light source 10 and the lens body 20.

Furthermore, the optical module 100 with the above configuration can provide a desired light distribution pattern only by adjusting an angular posture of the lens body 20 because the optical module 100 can be composed of a simple combination of the LED light source 10 and the lens body 20.

The optical module 100 with the above configuration can provide the directivity characteristics required for a road illumination light by the action of the cylindrically recessed light incident surface 21a. With such directivity, the optical module 100 can horizontally diffuse light beams to a wider horizontal area while effectively suppressing the upward light that may be a cause of glare light.

The optical module 100 with the above configuration can horizontally diffuse light to a wider area and illuminate a road surface including areas near its road shoulder between the adjacent optical modules 100 with light even if the optical modules 100 are disposed at certain intervals along the road shoulder. Accordingly, it is possible to improve the illumination uniformity (uniformity ratio of illuminance) in the illumination area.

In general, a convex lens can have a focal point on its center axis, and accordingly, if a light source is disposed on the center axis of the lens while being shifted upward, the projected light can be directed downward, thereby suppressing glare light generation to a driver of an oncoming vehicle to a minimum degree. In this case, however, since the physical relationship between the convex lens and the light source is altered, the light utilization efficiency may deteriorate in proportion to the shifted amount.

In contrast to this, the optical axis of the LED light source 10 and the optical axis of the lens body 20 can coincide with each other, and accordingly, the light utilization efficiency can be maintained. Furthermore, the lens body 20 can be designed to be a free curved lens for controlling the light distribution in which all the projected light beams can be directed downward. Namely, a general convex lens can provide an optical effect (the vertically symmetrical light beams are directed downward when being projected) by shifting the light source, for example, by the half thereof. The present exemplary embodiment can provide the optical effect by the vertical light distribution control.

Next, a description will be given of a lighting device 200 utilizing the optical modules 100 with the above configuration.

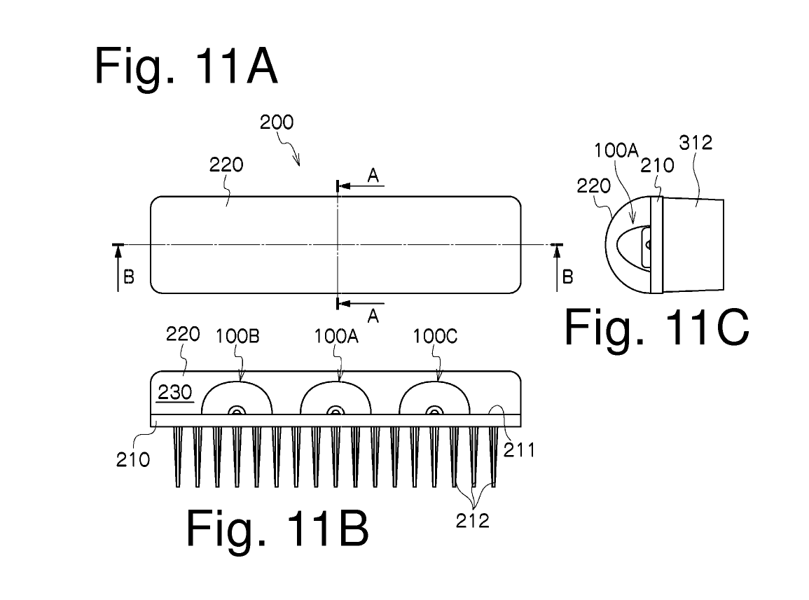

As shown in FIGS. 11A to 11C, the lighting device 200 can include a base plate 210, a cover 220, three optical modules 100 disposed within a lighting chamber 230, and the like. The optical modules 100 can include a first optical module 100A, a second optical module 100B, and a third optical module 100C.

The base plate 210 can include an optical module attached planar surface 211 to which the first to third optical modules 100A to 100C can be attached and a heat dissipation fin 212 fixed onto a rear surface of the planar surface 211 of the plate 210. The base plate 210 can be formed from a metal plate such as an aluminum plate.

The cover 220 can be attached to the base plate 210 to define the lighting chamber 230 together with the base plate 210. The cover 220 can be formed from a light transmitting material such as an acrylic resin, a polycarbonate resin, and the like.

The first optical module 100A can be fixed at or near a center of the optical module attached surface 211. The second optical module 100B and the third optical module 100C can be fixed to be disposed on respective sides of the first optical module 100A so that the cylindrical recessed portions (light incident surfaces 21a) of the respective optical modules 100A to 100C are allowed to be parallel with each other.

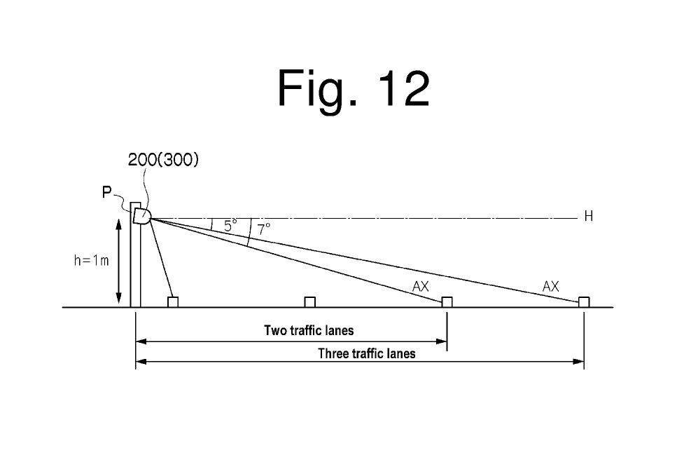

The lighting device 200 can be attached to a tip end of a low-position pole P with a length of approx. 1 m disposed along a road shoulder as shown in FIG. 12. Alternatively, the lighting device 200 can be attached to an upper edge of a not-shown guard rail (crush barrier) disposed along a road shoulder. The lighting device 200 can be adjusted in its posture to be attached with an attached angle of 5 degrees or 7 degrees, i.e., the optical axes AX of the respective optical modules 100A to 100C are directed by 5 degrees or 7 degrees downward with respect to the optical axis AX of the modules.

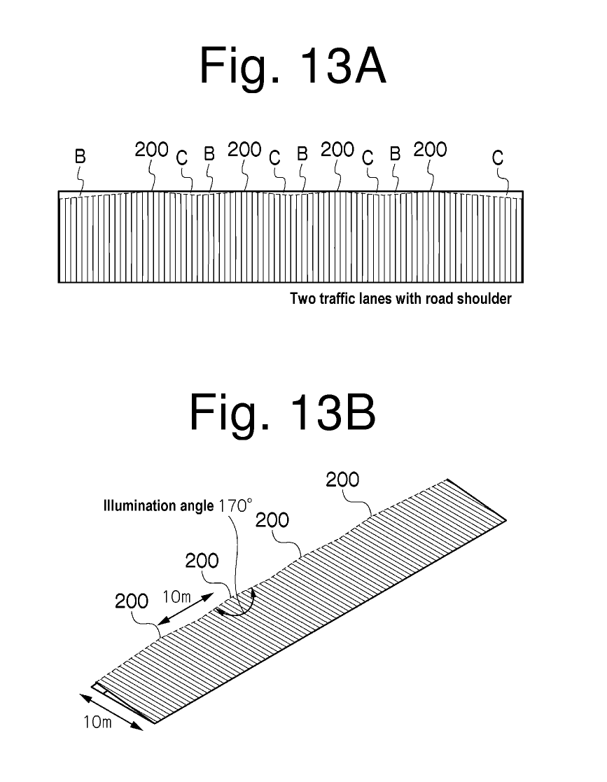

In the illustrated exemplary embodiment as shown in FIGS. 13A and 13B, the lighting devices 200 attached to the low-position poles P can be disposed at 10 m intervals.

The lighting device 200 with the above configuration can have a depth dimension that is significantly smaller than conventional lighting devices because the lighting device 200 can be composed of a simple combination of the LED light source 10 and the lens body 20.

The lighting device 200 with the above configuration can provide a desired light distribution pattern only by adjusting an angular posture of the lens body 20 because the lighting device 200 can be composed of a simple combination of the LED light source 10 and the lens body 20.

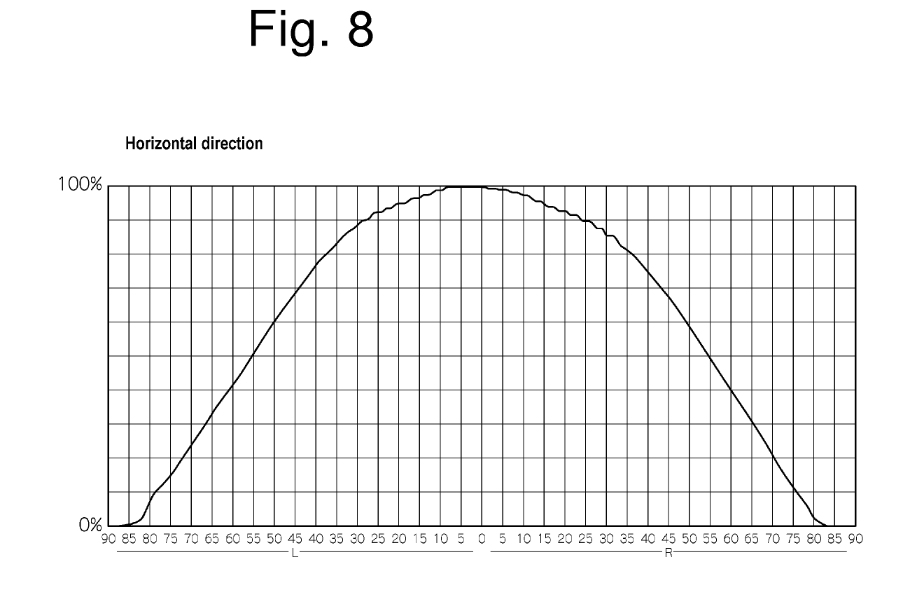

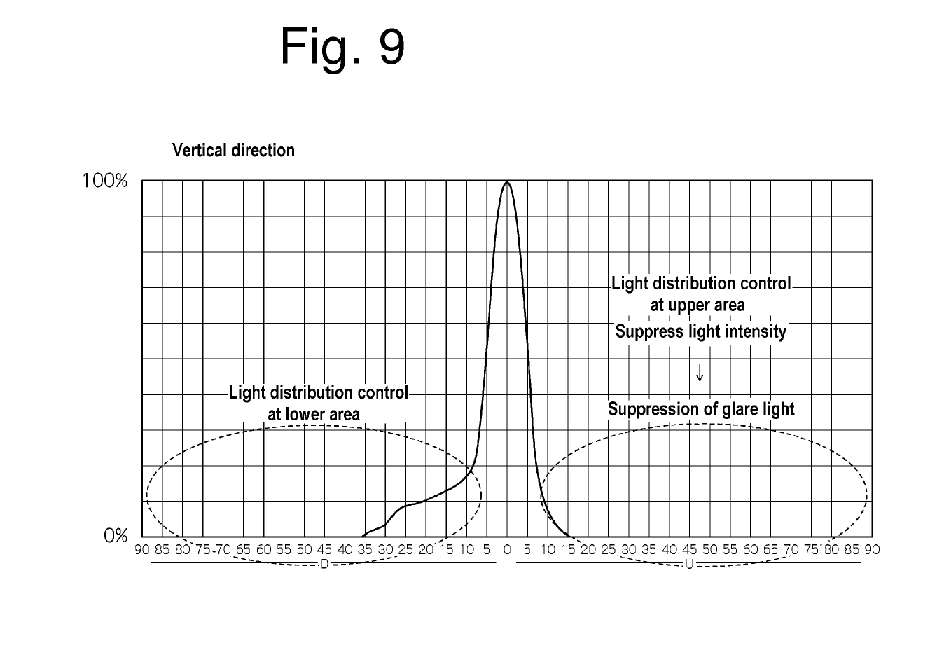

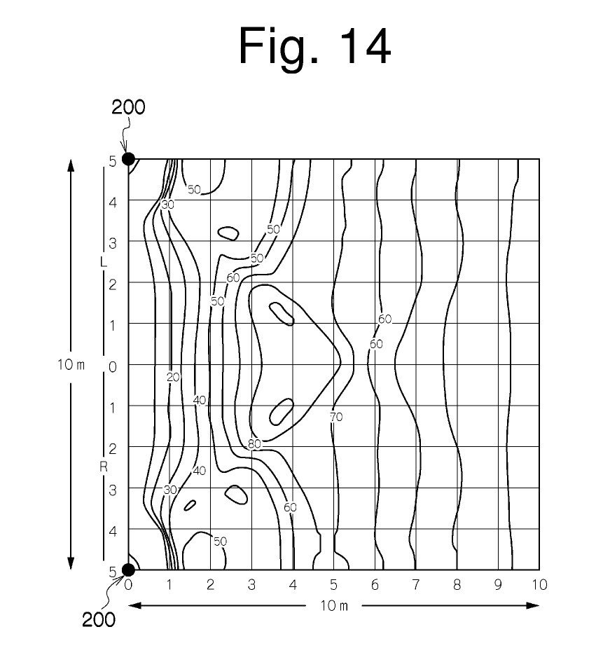

The lighting device 200 with the above configuration can provide the directivity characteristics required for a road illumination light by the action of the cylindrically recessed light incident surface 21a. With such directivity, the lighting device 200 can horizontally diffuse light beams to a wider horizontal area while effectively suppressing the upward light that may be a cause of glare light as shown in FIGS. 8 and 9. In addition to this, the lighting device 200 can form a road surface light distribution required for a road illumination light (for example, average road surface illuminance: 48 lx, uniformity ratio of illuminance: 0.55 or more, see FIG. 14).

The lighting device 200 with the above configuration can horizontally diffuse light to a wider area (for example, illumination angular range of 170 degrees, see FIG. 13B) and illuminate a road surface including areas near its road shoulder between adjacent lighting devices 200 with light even if the lighting devices 200 are disposed at certain intervals along the road shoulder. Accordingly, it is possible to improve the illumination uniformity (uniformity ratio of illuminance) in the illumination area.

The lighting device 200 with the above configuration can provide a horizontally wide light intensity (in the vehicle running direction of a road) in a wider illumination angular range while having directivity characteristics toward a wider sideward angular direction (see FIG. 8). Accordingly, the area between the illumination devices 200 and near the illumination devices 200 on the road shoulder can be compensated with the light with wider directivity characteristics. Accordingly, it is possible to improve the illumination uniformity in the illumination area of the road surface.

The lighting device 200 with the above configuration can ensure waterproof performance and the housing structure with the integrated heat radiation heat sink by the formation of the optical modules.

It should be noted that a control unit for driving and controlling the LED light source 10 can be attached to the attaching pole P together with the lighting device.

Next, a description will be given of a lighting device 300 utilizing the optical modules 100 with the above configuration.

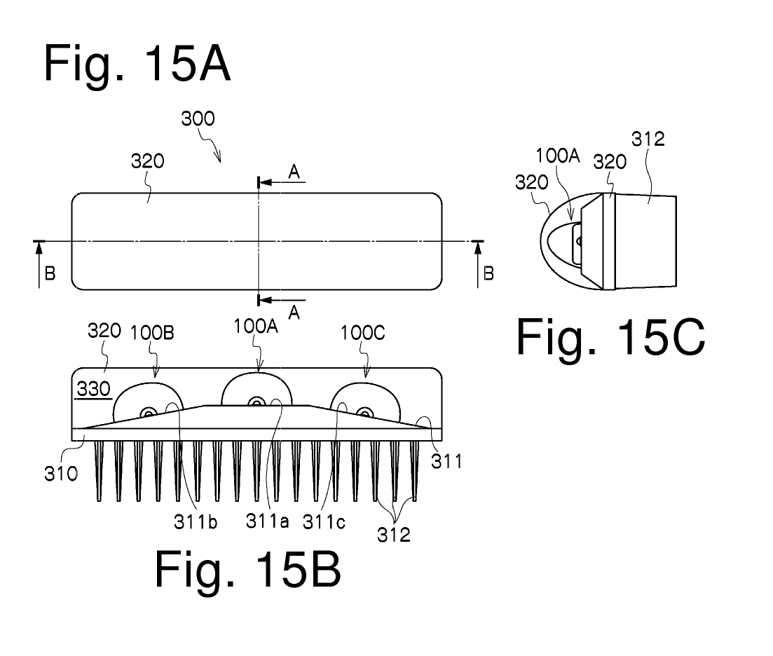

As shown in FIGS. 15A to 15C, the lighting device 300 can include a base plate 310, a cover 320, three optical modules 100 disposed within a lighting chamber 330, and the like. The optical modules 100 can include a first optical module 100A, a second optical module 100B, and a third optical module 100C.

The base plate 310 can include an optical module attached planar surface 311 to which the first to third optical modules 100A to 100C can be attached and a heat dissipation fin 312 fixed onto a rear surface of the planar surface 311 of the plate 310. The base plate 310 can be formed from a metal plate such as an aluminum plate. The optical module attached planar surface 311 can include a center planar surface 311a and inclined surfaces 311b and 311c disposed on respective sides of the center planar surface 311a.

The cover 320 can be attached to the base plate 310 to define the lighting chamber 330 together with the base plate 310. The cover 320 can be formed from a light transmitting material such as an acrylic resin, a polycarbonate resin, and the like.

The first optical module 100A can be fixed at the center planar surface 311a of the optical module attached surface 311. The second optical module 100B can be fixed at the inclined surface 311b of the optical module attached surface 311 (see FIG. 15B) with its posture inclined outward with respect to the first optical module 100A so that light projected from the second optical module 100B can cover an area outside a horizontally diffused area illuminated with light projected from the first optical module 100A (see the area B in FIG. 13A).

The third optical module 100C can be fixed at the inclined surface 311c of the optical module attached surface 311 (see FIG. 15B) with its posture inclined outward with respect to the first optical module 100A so that light projected from the third optical module 100C can cover an area outside a horizontally diffused area illuminated with light projected from the first optical module 100A (see the area C in FIG. 13A).

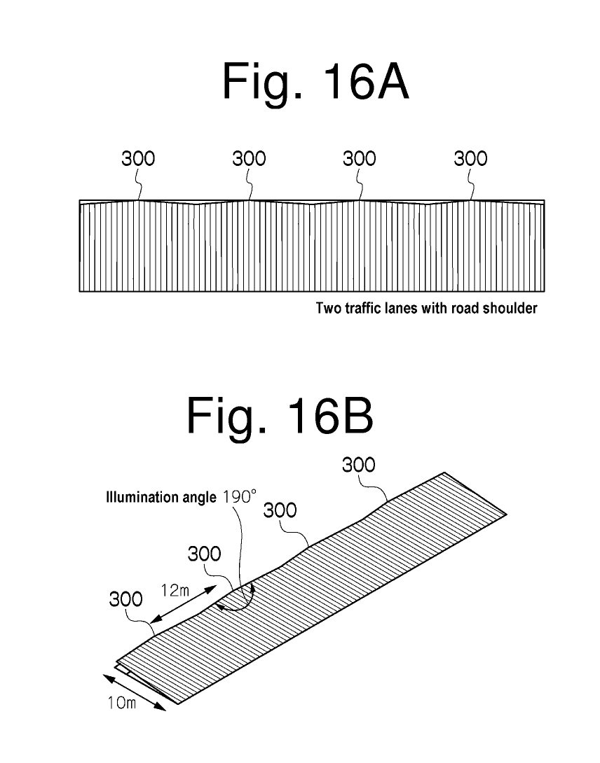

The lighting device 300 can be attached to a tip end of a low-position pole P with a length of approx. 1 m disposed along a road shoulder as shown in FIG. 12. Alternatively, the lighting device 300 can be attached to an upper edge of a not-shown guard rail (crush barrier) disposed along a road shoulder. The lighting device 300 can be adjusted in its posture to be attached with an attached angle of 5 degrees or 7 degrees, i.e., the optical axes AX of the respective optical modules 100A to 100C are directed by 5 degrees or 7 degrees downward with respect to the optical axis AX of the modules. In the illustrated exemplary embodiment as shown in FIGS. 16A and 16B, the lighting devices 300 attached to the low-position poles P can be disposed at 12 m intervals.

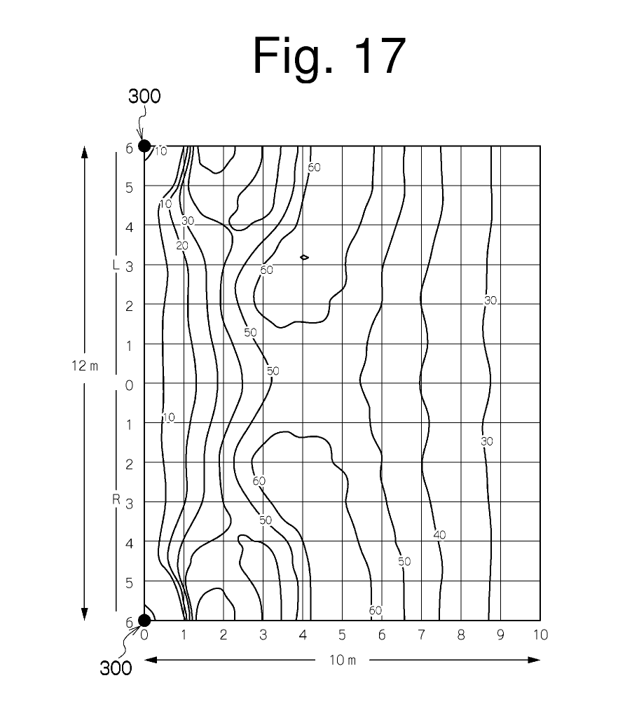

The lighting device 300 with the above configuration can provide the directivity characteristics required for a road illumination light by the action of the cylindrically recessed light incident surface 21a. With such directivity, the lighting device 300 can horizontally diffuse light beams to a wider horizontal area while effectively suppressing the upward light that may be a cause of glare light as shown in FIGS. 8 and 9. In addition to this, the lighting device 300 can form a road surface light distribution required for a road illumination light (for example, average road surface illuminance: 48 lx, uniformity ratio of illuminance: 0.58 or more, see FIG. 17).

In addition to this, the lighting device 300 can provide a horizontal illumination angular range wider than the lighting device 200 by the action of the second optical modules 100B and the third optical module 100C disposed in an inclined posture with respect to the first optical module 100 at their center. For example, the lighting device 300 can illuminate a wider area with the illumination angular range of 190 degrees as shown in FIG. 16B. Accordingly, this configuration can widen the disposing interval of the lighting device 300 from 10 m to 12 m.

Although the disposing interval is widened in the present exemplary embodiment, the lighting device 300 with the above configuration can improve the illumination uniformity in the road illumination area. Accordingly, the lighting device 300 with the above configuration can be applied to the case where a wider horizontal illumination angular range is required in a curved road.

It will be apparent to those skilled in the art that various modifications and variations can be made in the presently disclosed subject matter without departing from the spirit or scope of the presently disclosed subject matter. Thus, it is intended that the presently disclosed subject matter cover the modifications and variations of the presently disclosed subject matter provided they come within the scope of the appended claims and their equivalents. All related art references described above are hereby incorporated in their entirety by reference.

What is claimed is:

1. A lighting device comprising:
an LED light source; and
a lens body disposed in front of the LED light source so as to be opposed to the LED light source, the lens body including a front exiting surface and a rear surface, the rear surface including a light incident surface on which light emitted from the LED light source is incident, wherein
the light incident surface is a cylindrically recessed light incident surface that is formed by moving a concave semicircle section with respect to the LED light source in one direction to define a recessed space, and
the LED light source is disposed within the recessed space defined by the light incident surface so that the light emitted from the LED light source is incident on the light incident surface.

2. The lighting device according to claim 1, wherein the light exiting surface is a lens surface configured to horizontally diffuse the light that is emitted from the LED light source and which enters the lens body through the light incident surface, the light incident surface projecting light that illuminates within a range from an optical axis of the lens body up to 40 degrees.

3. The lighting device according to claim 1, wherein the light exiting surface is a lens surface that horizontally diffuses the light that is emitted from the LED light source and enters the lens body through the light incident surface in a horizontal angle range of from 85 degrees leftward to 85 degrees rightward and projects the light that illuminates within a vertical range from an optical axis of the lens body up to 40 degrees.

4. The lighting device according to claim 1, wherein the light exiting surface is a lens surface that horizontally diffuses the light that is emitted from the LED light source and enters the lens body through the light incident surface in a horizontal angle range of from 85 degrees leftward to 85 degrees rightward and projects the light that illuminates within a vertical range from an optical axis of the lens body up to 15 degrees.

5. A lighting device comprising a first optical module, a second optical module, and a third optical module, each of the first, second, and third optical modules including an LED light source and a lens body disposed in front of the LED light source and opposed to the LED light source, wherein
each lens body includes a front light exiting surface and a rear surface that includes a light incident surface on which light emitted from the LED light source is incident,
each light incident surface is a cylindrically recessed light incident surface that is formed by extending a concave semicircle section with respect to the LED light source in a direction to define a recessed space, and each LED light source is disposed within the recessed space defined by the light incident surface so that the light emitted from the LED light source is incident on the light incident surface, and
the second optical module and the third optical module are disposed on respective sides of the first optical module.

6. The lighting device according to claim 5, wherein the second optical module is inclined outward with respect to the first optical module so that light projected from the second optical module covers an area outside a horizontally diffused area illuminated with light projected from the first optical module, and
the third optical module is disposed inclined outward with respect to the first optical module so that light projected from the third optical module covers an area outside a horizontally diffused area illuminated with light projected from the first optical module.

7. A lighting device comprising:
an LED light source; and
a lens body disposed in front of and opposing the LED light source, the lens body including a front exiting surface and a rear surface, the rear surface including a light incident surface, wherein
the light incident surface defines a recessed space, and the light incident surface includes a vertically extending cylindrical recessed light incident surface, wherein
the LED light source is disposed within the recessed space.

8. The lighting device according to claim 7, wherein the light exiting surface is configured to diffuse light emitted by the LED light source in a horizontal direction in a range from 85 degrees in a leftward direction to 85 degrees in a rightward direction and wherein the light exiting surface is configured to project light within a vertical range from an optical axis of the lens body up to 40 degrees.

9. The lighting device according to claim 7, further comprising a first optical module, a second optical module, and a third optical module, wherein the second optical module is formed at an outward incline with respect to the first optical module so that light projected from the second optical module covers an area outside a horizontally diffused area illuminated with light projected from the first optical module, and wherein the third optical module is formed at an outward incline with respect to the first optical module so that light projected from the third optical module covers an area outside a horizontally diffused area illuminated with light projected from the first optical module.

10. A method of using the lighting device of claim 7, comprising:
emitting light by the LED light source in a horizontal direction in a range from 85 degrees in a leftward direction to 85 degrees in a rightward direction; and
emitting light within a vertical range from an optical axis of the lens body up to 40 degrees.
